(19) United States
(12) Patent Application Publication
(10) Pub. No.: US 2024/0336457 A1
(43) Pub. Date: Oct. 10, 2024

(54) Machine for moving objects such as stones, cut stone or agricultural products such as bales of hay, and depositing them at another location which machine has a front portion and a back or rear portion connected by a hydraulic joint which is able to steer the machine and move the back portion and also move the front portion and the back portion to more smoothly move over rough terrain

(71) Applicant: Levi Stauffer, JR., Marion Center, PA (US)

(72) Inventor: Levi Stauffer, JR., Marion Center, PA (US)

(21) Appl. No.: 17/803,564

(22) Filed: Aug. 26, 2022

(51) Int. Cl. B66C 13/12; B66C 3/02; B66C 23/18

(52) U.S. Cl. CPC B66C 23/18

(57) ABSTRACT

Disclosed is a machine having a front frame and a rear frame connected by a hydraulic powered articulated steering, and mechanism for 360° rotation of a digger, a dumper, a jack and a cab. The machine is used for moving objects such as stones, cut stone or agricultural products such as bales of hay, and depositing them at another location which has a front frame and a rear frame connected by a hydraulic joint. The hydraulic joint is able to steer the machine and also move the front frame and the rear frame to move substantially smoothly over a rough or uneven terrain.

### CROSS-REFERENCE TO RELATED APPLICATIONS

A provisional application entitled “Machine for Moving Objects Such as Stones, Cut Stone or Agricultural Products Such as Bales of Hay, and Depositing Them at Another Location Which Machine has a Front Portion and a Back or Rear Portion Connected by a Hydraulic Joint which is able to Steer the Machine and Move the Back Portion and also Move the Front Portion and the Back Portion to More Smoothly Move Over Rough Terrain,” Application No. 63/237,257, was filed on Aug. 26, 2021.

A provisional application entitled “A Machine for Moving Objects Such as Stones, Cut Stone or Agricultural Products Such as Bales of Hay, and Depositing Them at Another Location Which Machine has a Front Portion and a Back or Rear Portion Connected by a Hydraulic Joint which is able to Steer the Machine and Move the Back Portion and also Move the Front Portion and the Back Portion to More Smoothly Move Over Rough Terrain,” Application No. 63/474,618, was filed on Aug. 26, 2022.

### BACKGROUND

### 1. Technical Field

The present application generally relates to agriculture and other vehicles, and more particularly relates to an application having attachment units for rotation of a digger, a dumper and a cab.

### 2. Background Information

Known from the prior art are tractors which are typically provided with a three-point-mounting for mounting a plough or other attachments thereon. Further known are so-called backhoe loaders which provide an excavator-loader combination on wheels. A backhoe loader is a vehicle similar to a tractor and having at the rear a digging arm and at the front a loading bucket.

Earth moving and earth working apparatus are known. Earth working apparatus, such as earth excavation working apparatus typically comprises a main chassis which is supported on ground engaging wheels or tracks. Earth moving and earth working apparatus are known. Earth working apparatus, such as earth excavation working apparatus typically comprises a main chassis which is supported on ground engaging wheels or tracks.

Various patents are known in the art such as WO2001027397A1, CN200974980U, WO201389074, U.S. Pat. No. 8,002,074B2 and GB2184419A, discloses usage of a machine of digging, agriculture, and transportation purposes. Patents such as U.S. Pat. No. 8,764,369B2, and US20130236271A1 discloses bale spear in agriculture machines, U.S. Pat. No. 10,167,180B2 and U.S. Pat. No. 7,658,235B2 discloses usage of pallet forks in vehicles, U.S. Pat. Nos. 7,739,813B2 and 7,506,506B2 discloses usage of grading bucket in vehicles, U.S. Pat. Nos. 3,982,340A and 7,914,226B2 discloses usage of digging buckets in the excavator; and U.S. Pat. Nos. 7,322,133B2 and 6,385,870B1 discloses usage of hydraulic hammer in the excavator machines.

### SUMMARY

In accordance with teachings of the present application, a machine having attachment units for 360° rotation of a digger and a cab is provided.

An object of the present application is to provide a machine having a front frame and a rear frame connected by a hydraulic powered articulated steering, and mechanism for rotation of a digger, a dumper or a rear portion and a cab.

Another object of the present application is to provide a hydraulic motor for rotating the digger or grasping element to 360 degrees around the arm, and further providing a plurality of hydraulic actuators and a hydraulic outrigger.

An object of the present application is to provide a forestry management machine 109 (see FIG. 1) for processing residual fallen trees and tree tops into useful logs, firewood and burnable waste; a machine 109 (see FIG. 1) that provides the ability from the climate-controlled safety of the 2-man operator cabin 108 (see FIG. 1) to process the abovenamed.

An object of this machine 109 (see FIG. 1) is to enable elderly and/or disabled to safely and comfortably perform outdoor property maintenance and landscaping tasks not normally possible for elderly and/or disabled.

The above discussed, and subsequently discussed, exemplifications of the present device will be described further herein below. When the word “invention” or “exemplification of the invention” is used in this specification, the word “invention” or “exemplification of the invention” includes “inventions” or “exemplifications of the invention”, that is the plural of “invention” or “exemplification of the invention”. By stating “invention” or “exemplification of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and nonobvious one with respect to the other.

### BRIEF DESCRIPTION OF THE DRAWINGS

FIG. 1 Illustrates a side view of a machine; and

FIG. 1a Illustrates a side view of a machine with tailgate fully open; and

FIG. 2 Illustrates a dextral front isometric view of front chassis; and

FIG. 3 Illustrates a side view of rear chassis with dump body lifted and dumping; and

FIG. 3a Illustrates a side view of the machine with the dump body lifted and dumping; and

FIG. 3b Illustrates a side view of full machine dump body lifted dumping; and

FIG. 4 Illustrates a side view of independently rotatable boom apparatus; and

FIG. 5 Illustrates an anterior isometric view of machine cabin interior; and

FIG. 5a Illustrates a sinistral posterior isometric view of open power unit compartment;

FIG. 6 Illustrates a sinistral posterior isometric view of loading position; and

FIG. 7 Illustrates a dextral posterior isometric view of travel position; and

FIG. 8 Illustrates a top view of machine with power unit compartment secured; and

FIG. 9 Illustrates a top view of machine with power unit rotated out for accessibility; and

FIG. 10 Illustrates a side view of boom with the hydraulic forestry saw operative; and

FIG. 11 Illustrates a side view of boom with screw-type wood splitter operative; and

FIG. 12 Illustrates a side view of a machine gripping wood for loading, and

FIG. 13 Illustrates a top view of boom support plate with hydraulic fluid circuits; and

FIG. 14 Illustrates close-up view of hydraulic circuits and fluid swivel; and

FIG. 15 Illustrates boom support swivel w/gears, pinions, fluid swivel, and fluid circuits

FIG. 16 Illustrates close-up of fluid circuits routed through cab-mount bearing; and

FIG. 17 Illustrates side view of boom support swivel plate with boom hinge; and

FIG. 18 Illustrates front view of boom support swivel plate with vertical axis boom hinge;

FIG. 19 Illustrates bottom view of boom support swivel plate with boom rotation gear;

FIG. 20 Illustrates close-up of bottom view with view of multiple fluid circuit fittings;

FIG. 21 Illustrates side view of fluid swivel core with lands and grooves and end view of fluid swivel core with threaded fluid ports;

### DETAILED DESCRIPTION OF THE DRAWINGS

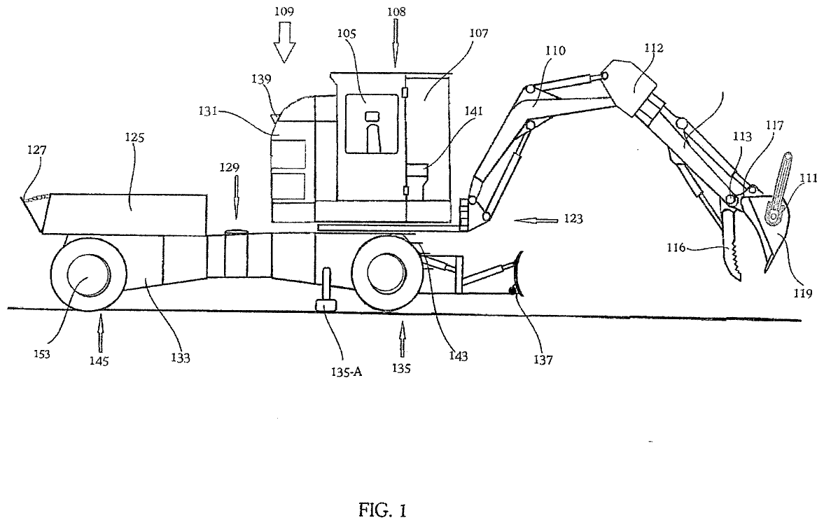

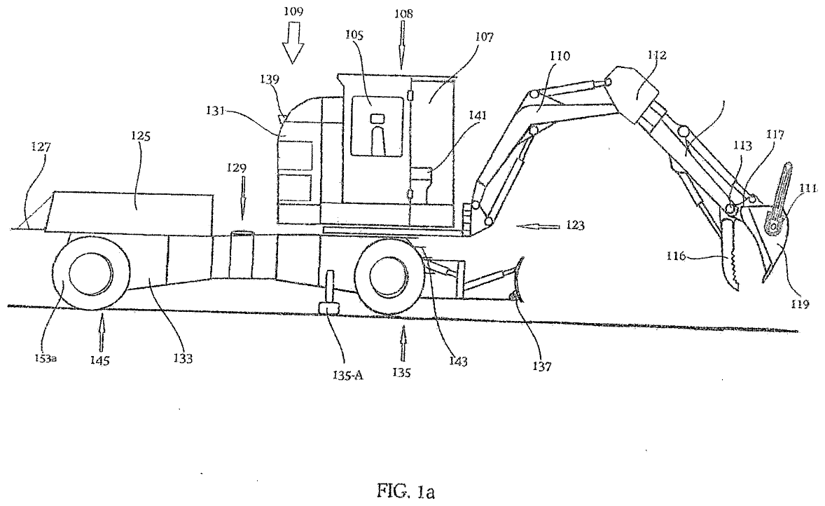

FIG. 1 Illustrates a side view of the 2-man operator cabin 108, machine 109, and boom 110 and passenger door 107. FIG. 1a Illustrates a side view of a machine with tailgate fully open; and

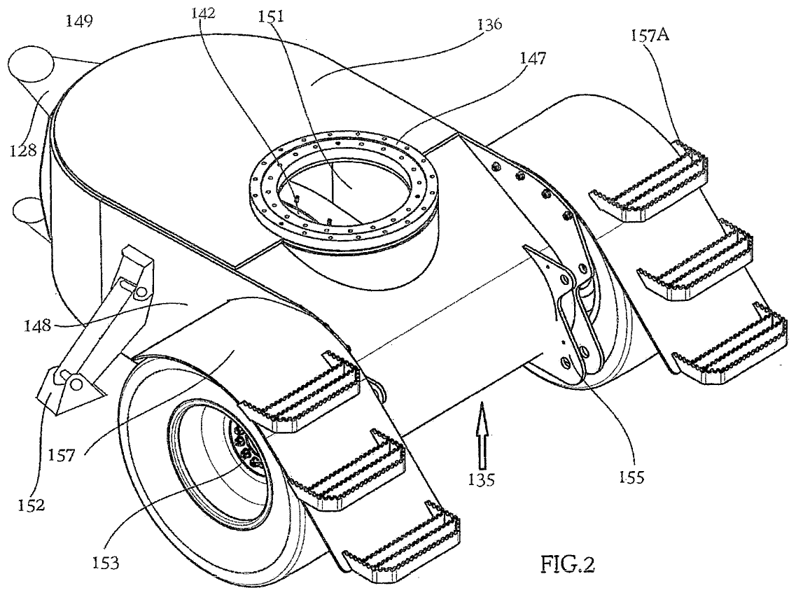

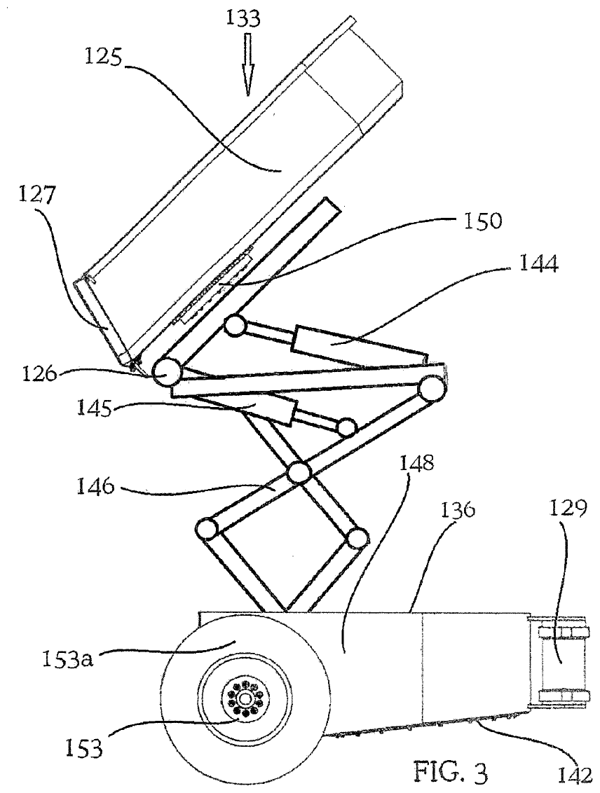

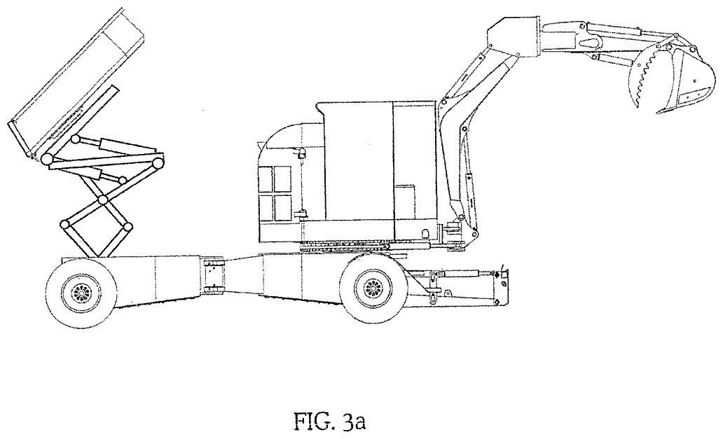

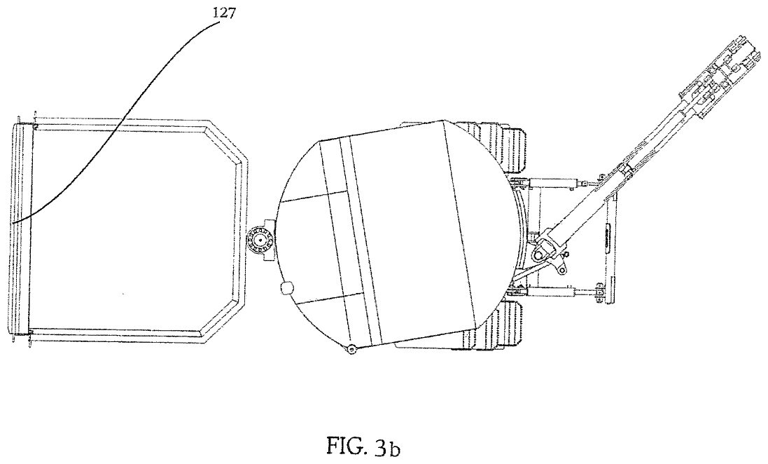

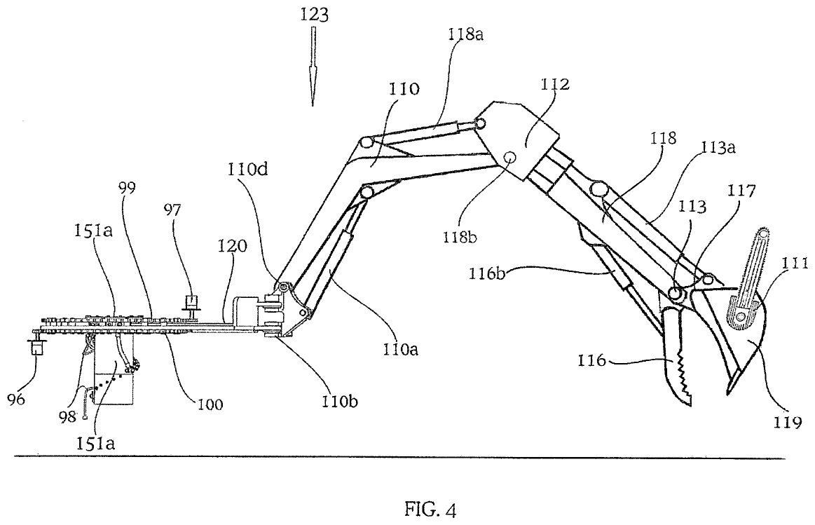

FIG. 2 Front chassis 135 includes a uni-body (one piece) water-jet machined, press-formed, welded steel plate frame 136 with a circular 24″ bolt-on steel access plate 142 bolted on base of front chassis 135 and a hydraulic 2-speed wheel final drive 153 attached through the anterior area of each front chassis frame sidewall 148, each hydraulically powered traction final drive 153 is fitted with wide flotation/traction tires 153a (see FIG. 3). Affixed to each front chassis frame sidewall 148 above the tires 153a (see FIG. 3) is a steel plate radius-formed wheel fender 157 rotated forward in an embodiment 12″ above ground level. Affixed to upper surface of each steel plate radius-formed fender 157 are serrated tread entry steps 157 A to facilitate safe entry of independently rotatable 1 or more man operator cabin. On each front chassis frame sidewall 148 behind hydraulic 2-speed wheel final drive 153 is affixed a hydraulically actuated front chassis outrigger 152. Affixed to each lateral extremity of the lower anterior vertical surface of front chassis 135 is a front tool coupler connector 155. On upper surface of front chassis 135 is affixed a boom swivel bearing 147 centered on circular port for flow-through fluid swivel 151 boom swivel bearing 147 enables attachment and continuous rotation of independently rotatable boom apparatus 123 (see FIG. 1, FIG. 4). Affixed to extreme posterior vertical surface of front chassis 135 is a horizontal axis (parallel to machine) limited flexion steering actuator connector device 128 enabling a limited (20° each side of vertical) horizontal flexion of front chassis 135 and rear chassis 133 (see FIG. 1, FIG. 3) relative to each other facilitating traction on rough or uneven terrain.

FIG. 3 Rear chassis 133 includes a uni-body (one piece) water-jet machined, press-formed, welded steel plate frame 136 with a circular 24″ bolt-on steel access plate 142 bolted on base of rear chassis 133 and a hydraulic 2-speed wheel final drive 153 attached through the posterior area of each rear chassis frame sidewall 148, each hydraulic 2-speed wheel final drive 153 is fitted with wide flotation I traction tires 153a. Affixed to extreme anterior vertical surface of rear chassis uni-body (one piece), water-jet machined, press-formed, welded steel plate frame 136 is a hydraulic rotary actuator steering device 129 enabling a limited up (up to 45° each side of 0°) flexion of front chassis 135 (see FIG. 1, FIG. 2) and rear chassis 133 relative to each other on a vertical axis facilitating steering of travel and positioning of machine 108 and attachments 111 & etc. (see FIG. 1). Installed inside uni-body (one piece), water-jet machined, press-formed, welded steel plate frame 136 is a hydraulically actuated dump body lift mechanism 146 enabling lifting of rotatable dump body 125 up to but not limited to 48″ above un-lifted rest position. Hydraulically actuated dump body lift mechanism 146 is powered by hydraulically operated dump body lift actuator 145. Affixed to upper surface of hydraulically actuated dump body lift mechanism 146 is affixed hydraulically operated dump actuator 144 enabling the rotatable dump body 125 to operate vertically from a posterior horizontal axis 126. Affixed to upper surface of hydraulically operated dump actuator 144 is dump rotation actuator 150 enabling limited rotation (up to 100° each side of normal rest position, up to 200° total rotation) of rotatable dump body 125. Affixed to upper surface of dump rotation actuator 150 is a rotatable dump body 125 enabling storage, transport, and placement (dumping) of cut stone, logs, firewood, pallet, crushed stone aggregate, top soil and etc. Dump body 125 includes a horizontal axis hinged tailgate 127 (see FIG. 1, FIG. 3b) comprising the posterior vertical plane of dump body 125. Horizontal axis hinged tailgate 127 (see FIG. 1, FIG. 3b) is hinged along lower edge of tailgate 127 on a horizontal axis extending along the posterior width of dump body base 125. Horizontal axis hinged tailgate 127 (see FIG. 1, FIG. 3a) facilitates containment of solids and aggregates in the closed position (see FIG. 3) and release of solids and aggregates for placement in the fully open (see FIG. 1a) position.

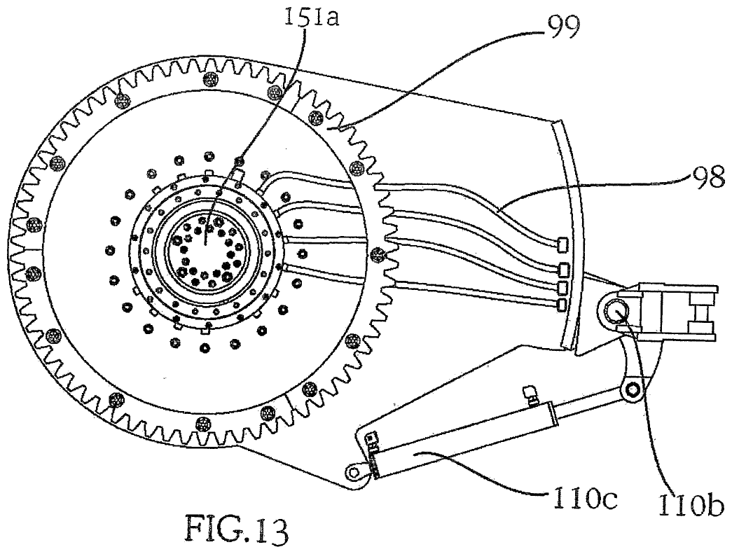

FIG. 4 Independently rotatable boom apparatus 123 includes boom support swivel plate 120 (see also attached FIGS. 13 through 21) boom support swivel plate 120 enables unlimited continuous rotation of independently rotatable boom apparatus 123 via an undermounted gear 100 engaged to boom rotation pinion gear actuator 96. Boom support swivel plate 120 attaches via boom swivel bearing 147 (see FIG. 2) to top offront chassis 135 (see FIG. 2) enabling unlimited rotation of independently rotatable boom apparatus 123. Affixed to upper surface of boom support swivel plate 120 (see also FIG. 13) is cabin rotation gear 99. Cabin rotation gear 99 (see also FIG. 13) facilitates continuous unlimited rotation of independently rotatable 2-man operator cabin 108 synchronously with or in simultaneous opposition to independently rotatable boom apparatus 123.

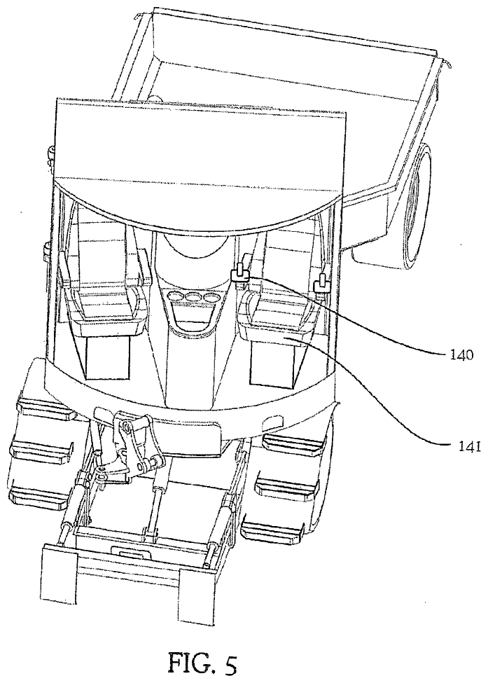

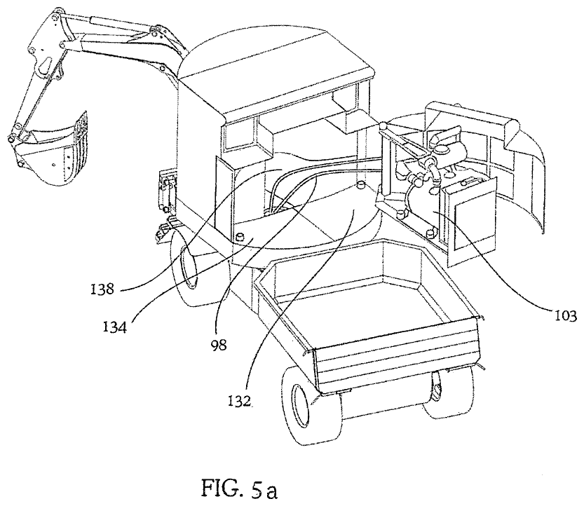

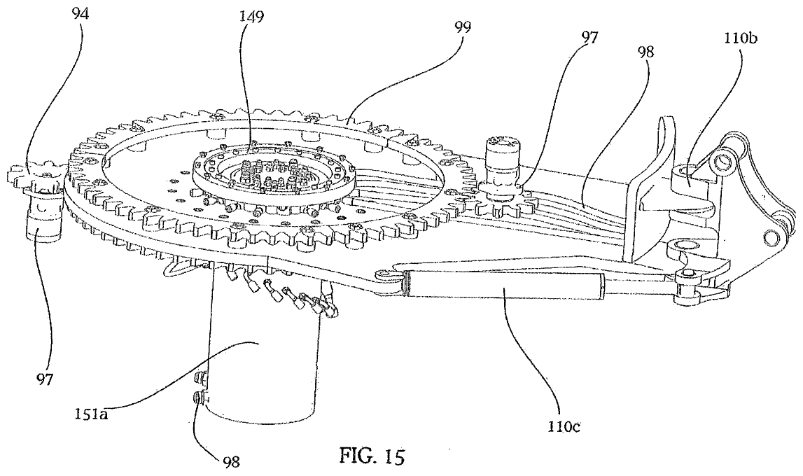

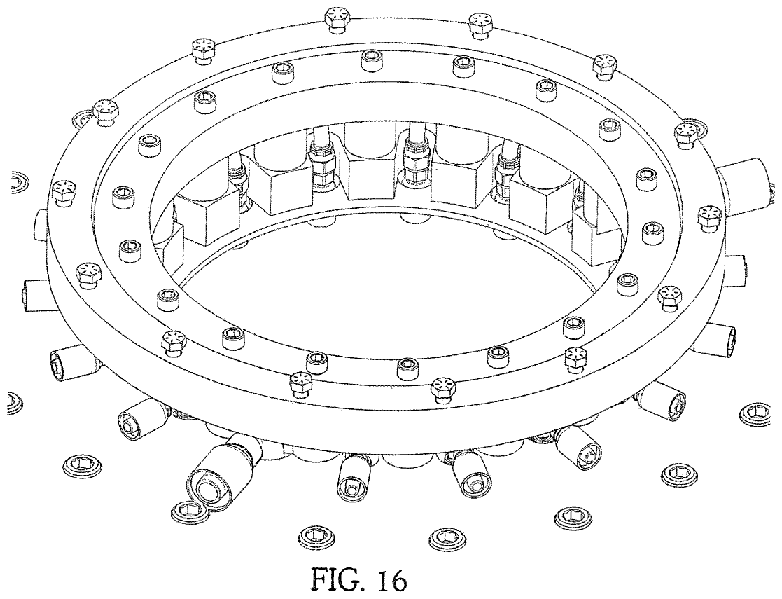

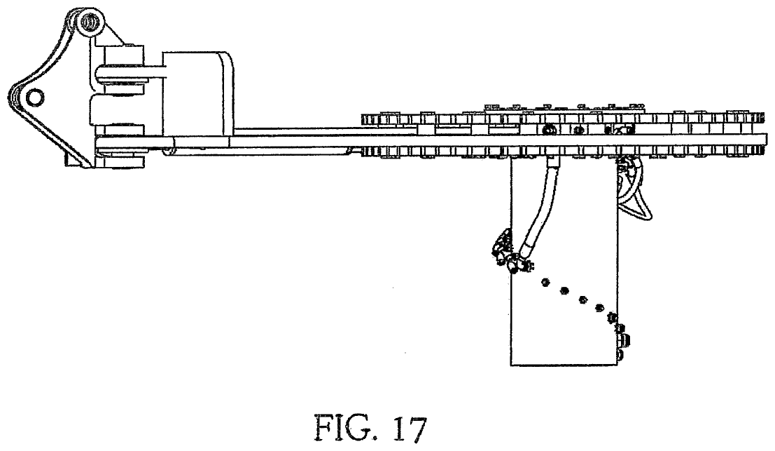

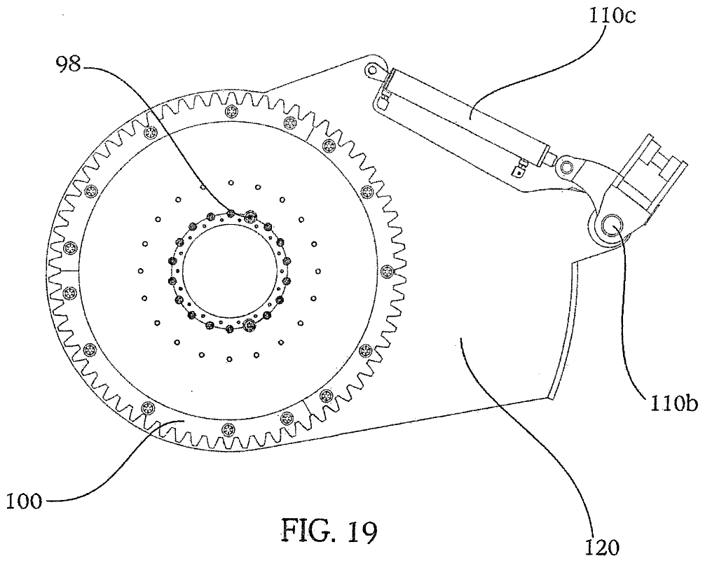

Boom support swivel plate includes machine central fluid swivel 151a (see also FIG. 17). Machine central fluid swivel 151a (see also FIG. 17) enables hydraulic fluid circuits 98 from power unit 103 (see FIG. 5) laterally (see also FIG. 15, FIG. 16, FIG. 17, FIG. 19) through boom support plate 120 to independently rotatable boom apparatus 123 enabling, but not limited to, hydraulically operated actuators 110a, 118a, 112, 113a, 116b, 117, 111 & etc. (see FIG. 4). Machine central fluid swivel 151a enables hydraulic fluid circuits from power unit 103 (see FIG. 5a) vertically through boom support plate 120 to front chassis 135 enabling tiltable manual quick attach for multiple hydraulic/non-hydraulic attachments including but not limited to brush mower, grading blade, road sweeper, motorized auger, compactor, material handling bucket, brush grapple, mulcher, chipper, stump grinder, and fork lift attachment; and enabling 2-speed hydraulic wheel final drive 153 and enabling hydraulic rotary actuator steering device 129 and enabling hydraulically actuated dump body lift mechanism 146 (see FIG. 3) and enabling hydraulically operated dump actuator 144 (see FIG. 3) and enabling, but not limited to, dump rotation actuator 150 (see FIG. 3).

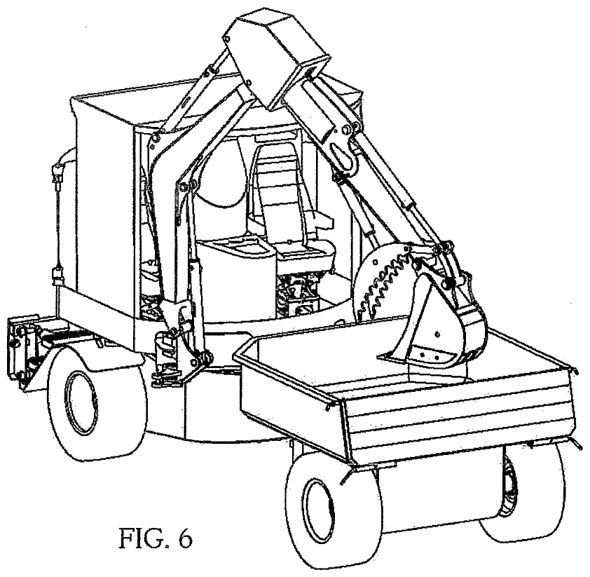

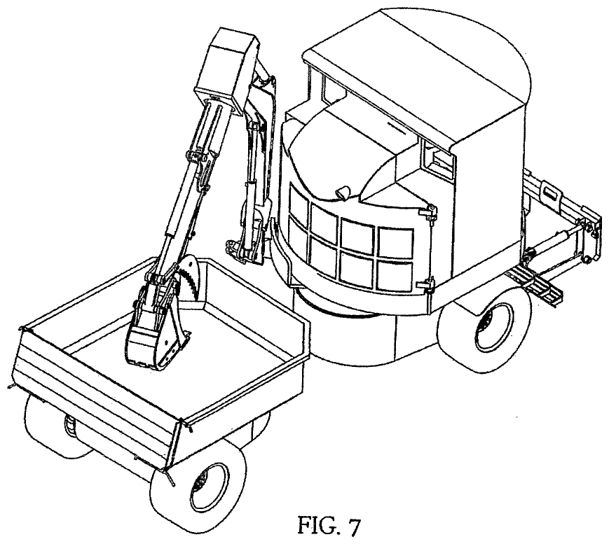

Independently rotatable boom apparatus includes boom hinge 11 Ob and boom hinge actuator 11 Oc (see FIG. 13) boom hinge 11 Ob enables lateral positioning of boom 110 on a vertical axis perpendicular or parallel to boom 110 (dependent on position of boom actuator 110a) to facilitate angles of excavation, loading of materials onto dump body 125 (see FIG. 6) and storage of boom for travel (see FIG. 7) and positioning of hydraulic remote quick attach 117 for multiple types of hydraulic/non-hydraulic attachments 111 (& 188 etc.) (see FIG. 1).

Independently rotatable boom apparatus 123 includes boom 110 and hydraulic remotely operated boom actuator 11 Oa. Boom actuator 11 Oa actuates boom 110 enabling reciprocal vertical limited angle flexion on a horizontal axis boom hinge-pin 11 Od installed perpendicular to boom 110. Boom enables reciprocal vertical actuation of boom stick rotator 112, boom stick 118, hydraulic remotely operated quick attach for multiple attachments 117 and, but not limited to, hydraulically operated forestry saw attachment 111 (& etc.), for excavation, loading, unloading, material and tool placement.

Independently rotatable boom apparatus includes hydraulic remotely operated boom stick rotator 112 enabling continuous unlimited bi-directional rotation of boom stick 118, hydraulic remotely operated quick attach for multiple attachments 117 and, but not limited to, hydraulically operated forestry saw attachment 111 (& etc.). Bi-directional rotation facilitates loading, unloading, positioning for excavation, and multiple tool positioning for operation of multiple procedures with multiple hydraulic/non-hydraulic tool attachments (111 & etc.).

Independently rotatable boom apparatus 123 includes boom stick 118. Boom stick 118 is actuated vertically on a horizontal axis 118b (see FIG. 4) perpendicular to boom 110 by hydraulic remotely operated boom stick actuator 118a (see FIG. 4) enabling bi-directional flexion on a horizontal axis 118b (see FIG. 4) perpendicular to boom 110 (see FIG. 4) facilitating loading, unloading, positioning for excavation, and multiple tool positioning for execution of multiple procedures with multiple hydraulic/non-hydraulic tool attachments.

Independently rotatable boom apparatus includes hydraulic remotely operated quick attach 117 for multiple types of hydraulic/non-hydraulic attachments 111 (& etc.). Hydraulic remotely operated quick attach for multiple types of attachments facilitates rapid remote attachment/detachment of non-hydraulic tool attachments and rapid Attachment/detachment of hydraulic tool attachments 111 (& etc.).

Independently rotatable boom apparatus includes thumb 116 to facilitate gripping, but not limited to, for lifting or breaking objects. Thumb 116 is actuated by hydraulic remotely operated thumb actuator 116b.

FIG. 5 Independently rotatable 1 or more man operator cabin 108 (see FIG. 1) includes two adjustable air-ride operator seats 141.

Independently rotatable 1 or more man operator cabin 108 (see FIG. 1) includes two polycarbonate resin thermoplastic operator/passenger doors 107 (see FIG. 1).

Independently rotatable 1 or more man operator cabin 108 (see FIG. 1) includes operator joy-stick machine controls 140.

Independently rotatable 1 or more man operator cabin 108 (see FIG. 1) includes side window 105 (see FIG. 1). Independently rotatable 1 or more man operator cabin 108 (see FIG. 1) includes power unit compartment 138 (see FIG. Sa).

Independently rotatable 1 or more man operator cabin 108 (see FIG. 1) includes power unit 103 (see FIG. Sa).

Independently rotatable 1 or more man operator cabin 108 (see FIG. 1) includes fuel storage tank 134 (see FIG. Sa). Independently rotatable 1 or more man operator cabin includes hydraulic fluid storage tank 132 (see FIG. Sa).

Independently rotatable 1 or more man operator cabin 108 (see FIG. 1) includes hydraulic fluid circuits 98 (see FIG. Sa).

Independently rotatable 1 or more man operator cabin 108 (see FIG. 1) includes cabin rotation pinion gear actuator 97 (see FIG. 4) attached vertically through base of independently rotatable 1 or more man operator cabin 108 (see FIG. 1) engaged in cabin rotation gear 99 (see FIG. 4) bolted to boom plate 120 (see FIG. 4).

An object of the present application is to provide a forestry management machine 109 (see FIG. 1) for processing residual fallen trees and tree tops into useful logs, firewood and burnable waste; a machine 109 (see FIG. 1) that provides the ability from the climate-controlled safety of the 2-man operator cabin 108 (see FIG. 1) to process the above-named. An object of this machine 109 (see FIG. 1) is to enable elderly and/or disabled to safely and comfortably perform outdoor property maintenance and landscaping tasks not normally possible for elderly and/or disabled.

FIG. 6 Illustrates a sinistral posterior isometric view of loading position; and

FIG. 7 Illustrates a dextral posterior isometric view of travel position; and

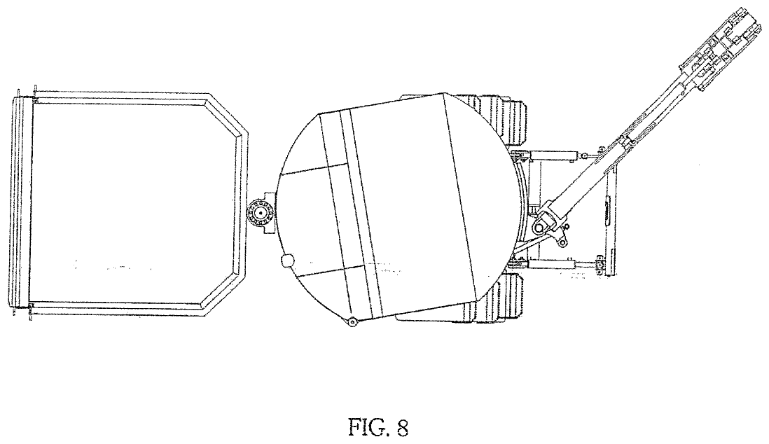

FIG. 8 Illustrates a top view of machine with power unit compartment secured; and

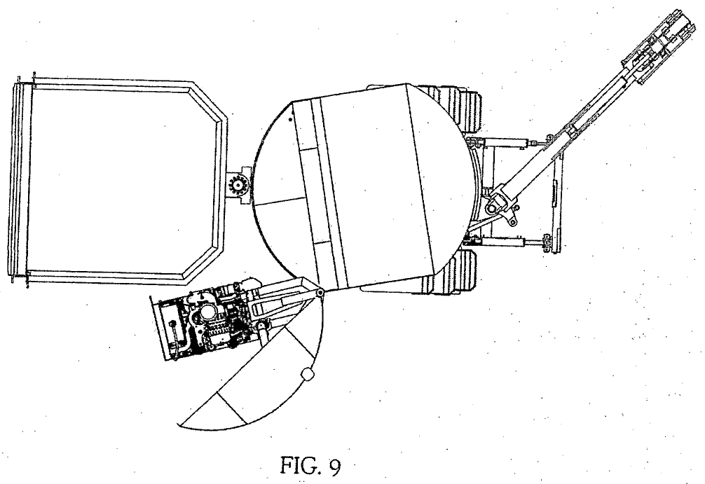

FIG. 9 Illustrates a top view of machine with power unit rotated out for accessibility; and

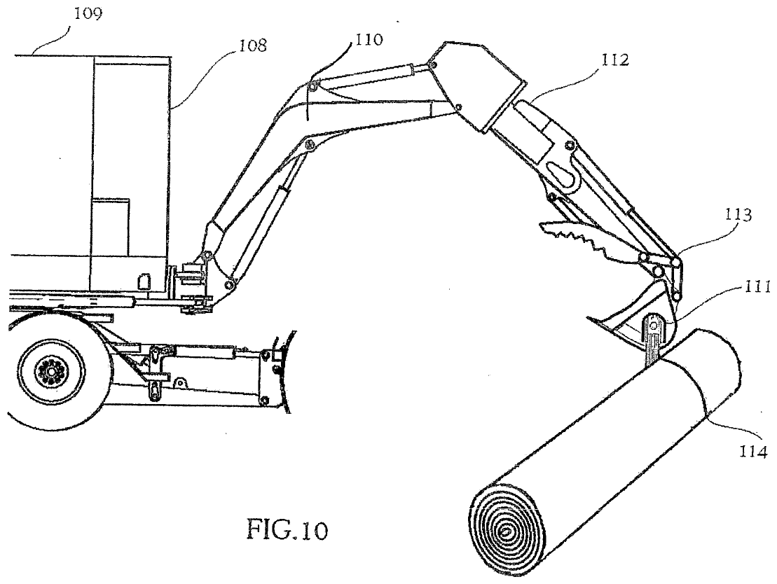

FIG. 10 Illustrates a side view of the machine boom 110 with a hydraulically operated forestry saw attachment 111 cutting a log 114. The boom stick rotator 112 and the bucket curl function 113 enable rotary and lateral positioning respectively of (but not limited to) the hydraulically operated forestry saw attachment 111.

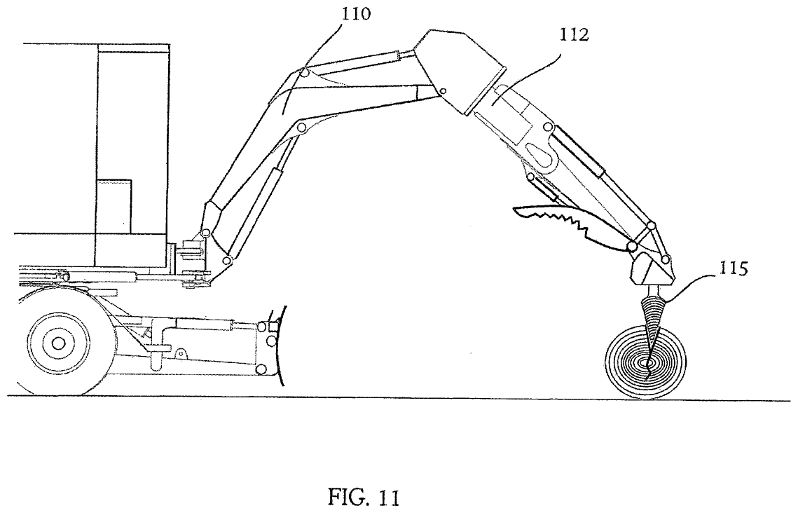

FIG. 11 Illustrates a side view of the machine boom 110 with a screw-type log splitter attachment 115 its rotary splitting motion enabled by the boom rotator 112 (and/or rotary hydraulic actuator) splitting a log 114; and

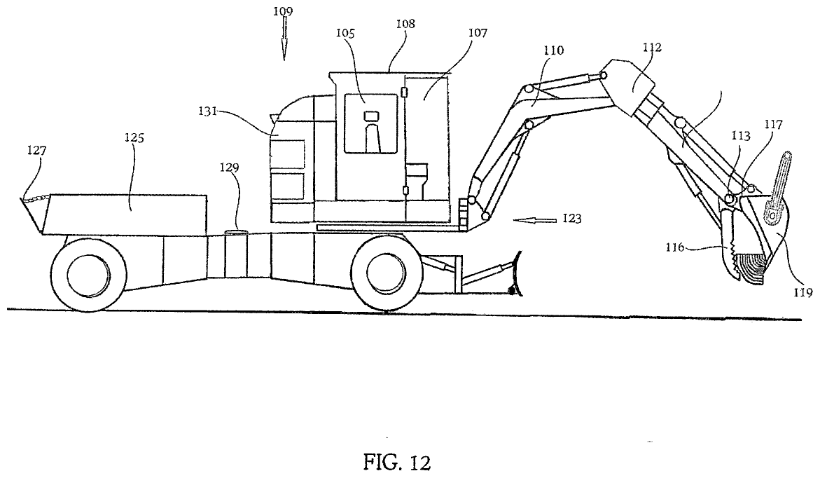

FIG. 12 Illustrates the 2-man operator cabin 108, with side window 105, operator door 107, and machine boom 110 with the hydraulically operated forestry saw 111 de-activated and the thumb gripping function 116 operational for loading processed wood.

FIG. 13 Illustrates a top view of boom support plate with hydraulic fluid circuits; and

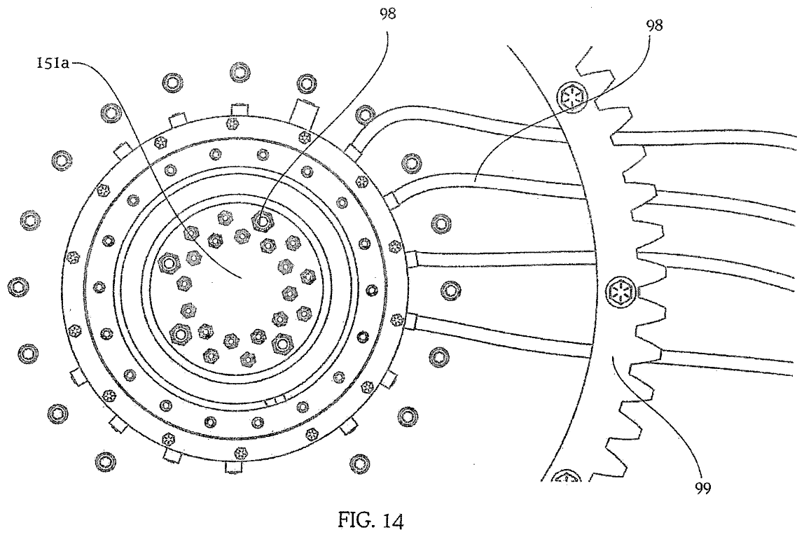

FIG. 14 Illustrates close-up view of hydraulic circuits and fluid swivel; and

FIG. 15 Illustrates boom support swivel w/gears, pinions, fluid swivel, and fluid circuits

FIG. 16 Illustrates close-up of fluid circuits routed through cab-mount bearing; and

FIG. 17 Illustrates side view of boom support swivel plate with boom hinge; and

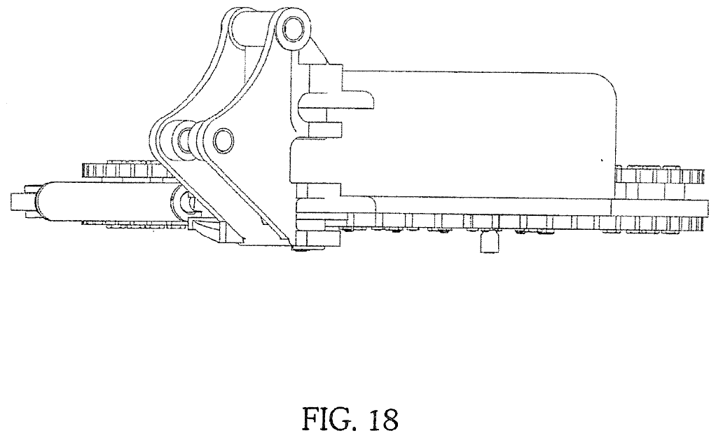

FIG. 18 Illustrates front view of boom support swivel plate with vertical axis boom hinge;

FIG. 19 Illustrates bottom view of boom support swivel plate with boom rotation gear;

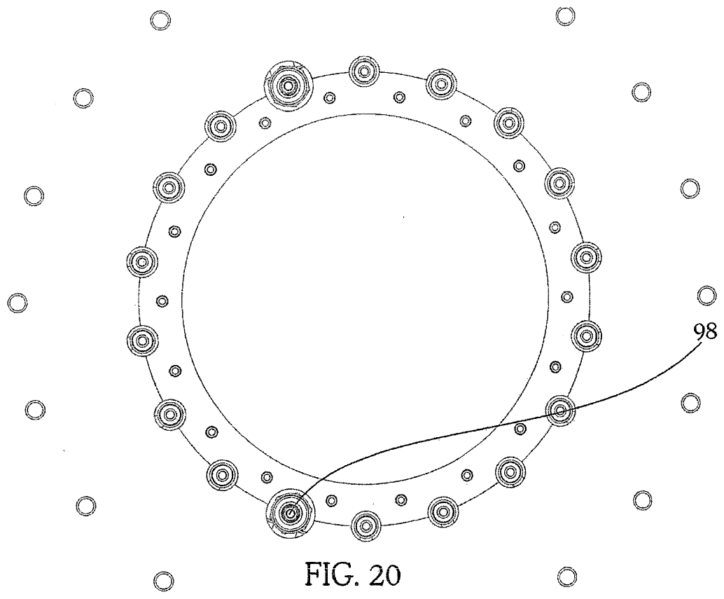

FIG. 20 Illustrates close-up of bottom view with view of multiple fluid circuit fittings;

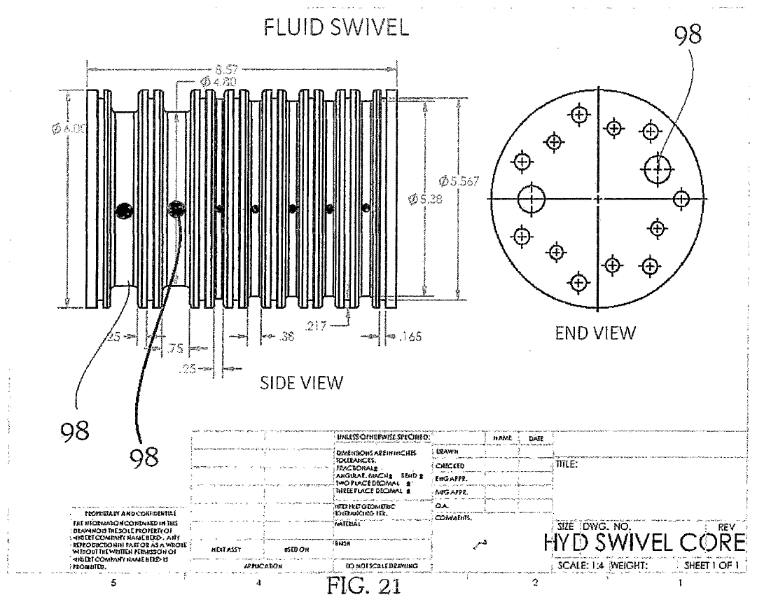

FIG. 21 Illustrates side view of fluid swivel core with lands and grooves and end view of fluid swivel core with threaded fluid ports;

1. Machine for moving objects such as stones, cut stones or agricultural products such as bales of hay comprising:
a two-part vehicle comprising a first portion and a second portion;
a connector between the said first portion and said second portion configured to steer said vehicle and permit the first part to move angularly with respect to said, second part to permit movement over rough terrain;
a cab comprising controls to permit the control of said machine;
said cab configured to rotate at least one complete rotation on said first portion;
an arm comprising at least two parts being configured to rotate about the same center of rotation as said cab;
said second portion comprising a hopper structure movably connected to second portion;
a jack connected to the front of said first portion;
an attachable scoop being connected to the end portion of said arm disposed furthest from said cabin;
a hydraulic connecting device been configured to permit the attachable scoop to be detached from said arm and other device to be attached to said arm to replace said scoop;
a hydraulic driving mechanism connected to control for said first portion of said machine and said second portion of said machine;
said arm been configured to be deposited at least partially in said hopper; and hydraulic outrigger connected to steady sound machine.
